(19) United States
(12) Patent Application Publication
(10) Pub. No.: US 2026/0362073 A1
(43) Pub. Date: Nov. 12, 2026

(54) AUDIO SYSTEM FOR SIMULATED IMMERSIVE AUDIO

(71) Applicant: Harman International Industries, Incorporated, Stamford, CT (US)

(72) Inventors: Riley WINTON, Opelika, AL (US); Rishi DAFTUAR, Ypsilanti, MI (US); Anne Margaret HAARA, Clinton Township, MI (US); Matthias von SAINT-GEORGE, Pfinztal (DE); Stefan HOLZHÄUSER, Ettlingen (DE); Chris LUDWIG, Bloomfield Hills, MI (US)

(21) Appl. No.: 19/395,691

(22) Filed: Nov. 20, 2025

Related U.S. Application Data
(63) Continuation-in-part of application No. 19/204,279, filed on May 9, 2025.

(51) Int. Cl. H04S 7/00; G06F 3/16

(52) U.S. Cl. CPC H04S 7/301; G06F 3/165; G06F 3/167; H04S 7/40; H04S 2400/13; H04S 2400/15

(57) ABSTRACT

An audio system includes at least one speaker configured to reproduce an audio output within a listening environment, a user interface configured to receive user input for adjusting a venue input setting for a desired simulated venue within the listening environment, and a microphone configured to capture ambient sound within the listening environment and generate a microphone signal. A controller in communication with the user interface is programmed to receive an audio source input signal, determine at least one simulated environmental parameter based on the venue input setting, generate an audio signal for the at least one speaker to adjust the audio output the based on the simulated environmental parameter, and transmit the audio signal to the at least one speaker.

### CROSS-REFERENCE TO RELATED APPLICATIONS

This application is a continuation-in-part of U.S. application Serial No. 19/204,279 filed May 9, 2025, the disclosure of which is hereby incorporated in its entirety by reference herein.

### TECHNICAL FIELD

Embodiments relate to an audio system for simulated immersive audio.

### BACKGROUND

Immersive audio systems have become increasingly important in automotive and consumer applications, as listeners seek more engaging and personalized sound environments.

One such system is described in U.S. Patent No. 10,324,683, which discloses an architecture for modifying in-vehicle audio playback based on ambient sound and environmental conditions. The system utilizes a microphone system operable to capture ambient sound in the acoustic environment and a signal processor operable to apply at least one signal processing algorithm to the audio signal based at least in part on the ambient sound.

### SUMMARY

In one or more embodiments, an audio system includes at least one speaker configured to reproduce an audio output within a listening environment, a user interface configured to receive user input for adjusting a venue input setting for a desired simulated venue within the listening environment, and a microphone configured to capture ambient sound within the listening environment and generate a microphone signal. A controller in communication with the user interface is programmed to receive an audio source input signal, determine at least one simulated environmental parameter based on the venue input setting, generate an audio signal for the at least one speaker to adjust the audio output the based on the simulated environmental parameter, and transmit the audio signal to the at least one speaker.

In one or more embodiments, the controller is further configured to store a plurality of preset venues, each preset venue being defined by at least two venue input settings selected from the group consisting of: a venue width, a venue size, and a listener position, a venue height input, a venue material input, and a venue enclosure input. In one or more embodiments, the plurality of preset venues includes a plurality of venue presets including at least a first venue preset, a second venue preset, and a third venue preset, each of the plurality of venue presets being configured with predefined values for the at least two venue input settings, wherein the first venue preset corresponds to the venue width and the venue size being small and less than the second venue preset and the third venue preset, wherein the second venue preset corresponds to the venue width and the venue size being midsized and less that the third venue preset, and wherein the third venue preset corresponds to the venue width and the venue size being large and greater than the first venue preset and the second venue preset. In one or more embodiments, the user interface comprises a venue width input and a venue size input configured to allow a user to modify one or more of the plurality of venue presets.

In one or more embodiments, the controller is further programmed to process the microphone signal to apply the at least one simulated environmental parameter such that the audio output includes a processed ambient sound from the microphone based on the simulated environmental parameter. In one or more embodiments, the controller is further programmed to: receive an audio input signal indicative of an audio playback level and a volume control signal indicative of a playback volume setting, and adjust a gain applied to the microphone signal based on the playback volume setting. In one or more embodiments, the controller is further programmed to adjust the gain to the microphone signal in real time during playback of the audio source input signal. In one or more embodiments, the controller is further programmed to continuously monitor the audio playback level and the playback volume setting and dynamically update the gain without interrupting or delaying the playback of the audio source input signal.

In one or more embodiments, the at least one simulated environmental parameter comprises a venue material parameter corresponding to one or more acoustic properties of a material associated with the desired simulated venue, and the controller is configured to apply the venue material parameter to modify the audio source input signal. In one or more embodiments, the at least one simulated environmental parameter comprises a venue enclosure parameter indicating whether the desired simulated venue is open-air or enclosed, and the controller is configured to modify the audio source input signal based on the venue enclosure parameter.

In one or more embodiments, the user interface is configured to receive an input of a selected known venue from a user, and the controller is programmed to apply the at least one simulated environmental parameter associated with the selected known venue. In one or more embodiments, the controller includes a lookup table (LUT) that includes the selected known venue and the at least one simulated environmental parameter associated with the selected known venue. In one or more embodiments, the controller is programmed to access remote venue information for the selected known venue, analyze the remote venue information, and determine the at least one simulated environmental parameter associated with the selected known venue.

In one or more embodiments, the user interface is implemented on a mobile computing device configured to communicate with the controller, wherein the mobile computing device is configured to transmit the venue input setting associated with the desired simulated venue to the controller via a wired or wireless communication link. In one or more embodiments, the user interface comprises a graphical user interface integrated into a vehicle. In one or more embodiment, the user interface further comprises a voice control system configured to receive spoken commands from a user for adjusting the venue input setting. In one or more embodiments, the controller is further programmed to receive a first signal from the user interface with a first venue input setting, determine a first simulated environmental parameter based on the first venue input setting, generate a first output signal, receive a second signal from the user interface with a second venue input setting, determine a second simulated environmental parameter based on the second venue input setting, and generate a second output signal in real-time.

In one or more embodiments, the at least one simulated environmental parameter comprises a reverb effect applied to the audio source input signal. In one or more embodiments, the at least one simulated environmental parameter comprises at least one of a surround sound effect, a distance effect, or a reverb effect. In one or more embodiments, the user interface further comprises a plurality of user interface elements for adjusting in real time at least one of a width, a size, or a seating position within the desired simulated venue.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIGS. 1A and 1B illustrate a system and control for simulated immersive audio according to at least one embodiment of the present disclosure;

FIG. 2 illustrates an example of an audio effects application of FIGS. 1A and 1B applying audio effects to an audio input signal associated with an audio source according to at least one embodiment of the present disclosure;

FIG. 3 illustrates a system for adjusting gain in a captured audio input signal according to at least one embodiment of the present disclosure;

FIG. 4 illustrates a user interface according to at least one embodiment of the present disclosure;

FIG. 5 illustrates a user interface according to at least one embodiment of the present disclosure;

FIG. 6 illustrates a user interface according to at least one embodiment of the present disclosure;

FIG. 7 illustrates a user interface according to at least one embodiment of the present disclosure; and

FIG. 8 illustrates a user interface according to at least one embodiment of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

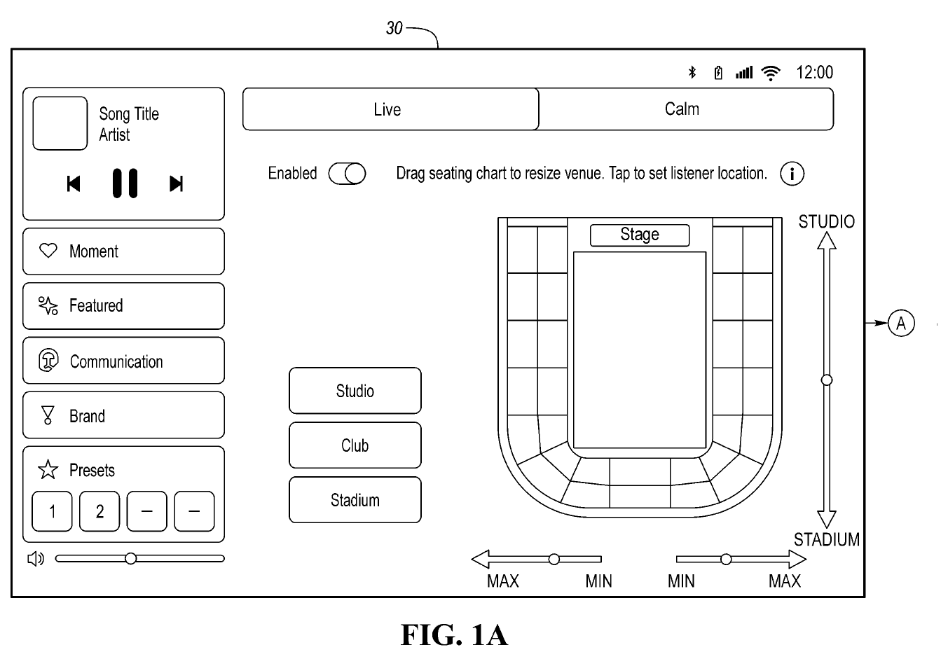

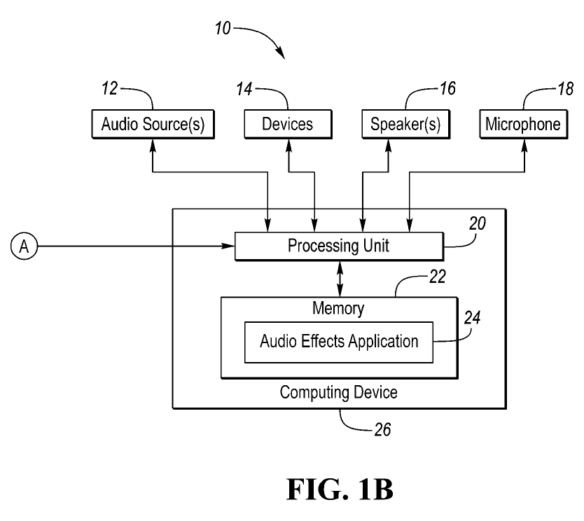

Embodiments disclosed herein relate to an audio system and method for providing immersive audio and customizable audio experience. FIGS. 1A-1B illustrate an audio system 10 for use in vehicles or other listening spaces. As illustrated, the audio system 10 includes media or audio sources 12, input and output devices 14, speakers 16, a user interface 30 and a computing device 26. The computing device 26 includes a processing unit 20 and memory 22. The memory 22 stores an audio effects application 24.

The user interface 30 allows listeners to configure a simulated listening environment by selecting parameters such as venue type, venue size or length, venue width, and listener/seating position, among others. These inputs adjust how audio is processed and played back to emulate different acoustic venues, like a studio or a stadium.

The audio system 10 provides immersive audio that allows users to create and personalize their own listening environment by adjusting parameters that control their perception of the venue. These parameters include the overall venue size, the listener’s distance from the sound source (such as choosing a seat or row in a concert hall), and the level of immersion, which relates to how much the acoustics of the simulated space affect the sound—roughly corresponding to the amount of reverb. Using the user interface 30, users can build a virtual sound stage to match their personal preferences. Each element of the venue can be adjusted in real time, giving users direct control over how immersive or intimate the audio feels, and enabling them to fine-tune each listening session.

While prior systems adjust the playback audio signal according to the ambient sound or changes in the vehicle state, they do not allow direct control over the perceived spatial configuration of the sound field or provide a way for the user to construct and interactively modify a custom venue experience in real time. Further, prior audio systems do not offer granular control over multiple parameters such as venue width, venue size or length, and listener/seat positioning.

Beyond these parameters of venue width, venue size or length, and listener/seat position, the audio system 10 may further incorporate characteristics of the venue itself, such as the materials and enclosure type, or even emulate specific known venues, to provide an even more realistic and customizable listening experience.

In some embodiments, the audio system 10 may simulate the acoustic properties of different venues by adjusting parameters that reflect how sound behaves in real spaces. These acoustic environment parameters can include characteristics such as the types of materials present, the overall size and geometry of the venue, and whether the venue space is open-air or enclosed. Each of these factors influences how sound reflects, absorbs, and reverberates, shaping the listener’s sense of immersion.

In further embodiments, the audio system 10 may extend beyond generic parameters to replicate specific, real-world venues. A user may select a known venue, such as an amphitheater or stadium, and the audio system 10 may apply algorithms, including artificial intelligence or machine learning models, to characterize that venue’s acoustic signature. These models may draw on available data sources to generate input settings that emulate the distinctive sound of the selected location, enabling playback that closely mirrors the listener’s experience within that space.

Referring again to FIGS. 1A-1B, the computing device 26 may be a controller or an audio processor, such as a vehicle audio system, a home theater system, sound system, and/or similar system/device. In some embodiments, computing device 26 is included in one or more devices, such as consumer products (e.g., portable speakers, gaming consoles, entertainment systems, etc.), vehicles (e.g., the head unit of a car, truck, van, bus, train, airplane, DSP smart amplifier etc.), smart home devices (e.g., smart lighting systems, security systems, digital assistants, etc.), communications systems (e.g., conference call systems, video conferencing systems, speaker amplification systems, etc.), mobile devices (e.g., smart phones, tablets, etc.), computers, and so forth. In some embodiments, computing device 26 is located in various acoustic environments including, without limitation, vehicles, indoor environments (e.g., living room, conference room, conference hall, home office, etc.), and/or outdoor environments, (e.g., patio, rooftop, garden, etc.). The computing device 26 is configured to receive one or more user settings from which a simulated listening environment is determined. Computing device 26 is further configured to generate audio effects based on the simulated listening environment, which are applied to the one or more audio sources 12 when played back within a listening environment.

The one or more audio sources 12 can include any technically feasible device or component capable of providing audio signals to computing device 26. For example, each of the one or more audio sources 12 can be an on-board media player, a streaming service accessed via a network connection, a media stream (e.g., from a cellular or smart telephone), or a storage device containing stored music, movie soundtracks, spoken word content, and/or other audio files. In some examples, the one or more audio sources 12 include audio from a voice call that is in communication with computing device 26. For example, a user can initiate or receive a voice call or a video call using a mobile device in communication with computing device 26. Each of the one or more audio sources 12 can adapt or switch content based on user preferences or selections, sensor input, system configurations, and/or the like.

The input and output devices 14 include any technically feasible kind of device and/or interfaces through which the audio system 10 can interact with the environment or users. The input and output devices 14 can be used to receive input and can include, without limitation, keyboards, knobs, buttons, sliders, touch screens, and/or the like. The input and output devices 14 can also be used to receive information from the environment and can include, without limitation, microphones, cameras, proximity sensors, or other input devices capable of detecting seat occupancy, background noise levels, and/or user commands. The input and output devices 14 can also include devices configured to provide output. For example, input and output devices 14 can include, without limitation, a display device (e.g., an LCD display, a heads-up display, etc.), haptic feedback elements and/or the like. The input and output devices 14 can be used to present system information to one or more users and/or allow the one or more users to select from among different configuration settings. Additionally or alternatively, the input and output devices 14 can further include devices configured to both receive input and provide output, including, for example, a touchscreen and/or the like.

The one or more speakers 16 convert processed audio signals into audible sound for one or more users. Located within an environment, such as a vehicle cabin, sound output by the one or more speakers 16 play back sound based on audio signals received from audio effects application 24. Each of the one or more speakers 16 can be any technically feasible type of speaker.

Microphone system 18 includes one or more microphones that are positioned within the listening environment. Microphone system 18 can capture sounds within the listening environment such as audio that is played back by the one or more speakers 16. Microphone system 18 can further isolate the audio played back within the listening environment from other sounds captured by the microphone system 18, such as road noise, voice sounds, vehicle noise, or other noises within or external to the vehicle. Microphone system 18 then provides the isolated audio to computing device 26 as a microphone input signal. Microphone system 18 can include an array of microphones that are positioned throughout the listening environment. For example, in a vehicle environment, microphone system 18 includes microphones that are installed in the dash, ceiling, pillars, headrests, or other locations of the vehicle.

Processing unit 20 controls the overall operation of computing device 26. Processing unit 20 is configured to read and write data from memory 22. Processing unit 20 can include any suitable hardware processor or combination of hardware processors, including one or more central processing units (CPUs), graphics processing units (GPUs), digital signal processors (DSPs), field-programmable gate arrays (FPGAs), or application-specific integrated circuits (ASICs), and/or any other type of processing unit, or a combination of processing units, such as a CPU configured to operate in conjunction with a GPU. In general, processing unit 20 can be any technically feasible hardware unit capable of processing data, executing instructions, and/or performing signal processing tasks, such as the signal processing task of audio effects application 24.

Memory 22 can include a random-access memory (RAM) module, a flash memory unit, or any other type of memory unit or combination thereof. The processing unit 20 is configured to read data from and write data to memory 22. In various embodiments, memory 22 includes non-volatile memory, such as optical drives, magnetic drives, flash drives, or other storage. In some embodiments, separate data stores, such as an external data stores (not shown) included in a network (“cloud storage”) can supplement the memory 22. The audio effects application 24 within memory 22 can be executed by the processing unit 20 to implement the overall functionality of the computing device 26 and, thus, to coordinate the operation of the audio system 10 as a whole.

The audio effects application 24 controls the audio processing workflow, using data from the input and output devices 14 and/or the microphone system 18, and configurations from one or more users to generate audio effects that are applied to an audio input signal. In operation, audio effects application 24 receives one or more user settings via the input and output devices 14, where the one or more user settings correspond to properties for a simulated listening environment. The audio effects application 24 generates effects processing parameters that specify one or more audio effects applied to an input signal to generate an output signal. The audio effects include surround effects, distance effects, or reverb effects. The simulated listening environment represents a customized room or venue in which the user listens to the one or more audio sources 12 being played back the by one or more speakers 16. A simulated listening environment simulates an environment that includes a stage, sound source, sound stage, or a directional source of the audio, such as the front of the room. For example, the simulated listening environment could correspond to a studio, a club, an arena, or a stadium environment. In the case of a studio, audio effects application 24 causes a more accurate representation of the one or more audio sources 12 to be played back by the one or more speakers 16. In the case of a stadium environment, audio effects application 24 causes a more effects-driven reproduction of the one or more audio sources 12 that includes distance, reverb and/or surround sound effects to provide the user with the sensation of listening to the one or more audio sources 12 in a stadium. The one or more user settings are presented to a user via a user interface rendered by the input and output devices 14, such as on a touchscreen display within the listening environment. The one or more user settings pertain to a venue type that can be selected by the user as well as other properties about the dimensions of the venue type. For example, the venue type selectable by the user includes a studio environment, a club environment, or an arena environment, or a stadium environment.

If the user selects a studio environment, audio effects application 24 minimizes the surround effects, distance effects or reverb effects that are applied to an audio output signal. If the user selects a club environment, audio effects application 24 adds surround effects, distance effects, and reverb effects to the output signal. If the user selects an arena or stadium environment, audio effects application 24 adds even more surround effects, distance effects, and reverb effects to the output signal.

The one or more user settings include further customizations to the audio effects generated by the audio effects application 24 in addition to selection of a venue type. In some implementations, a user specifies a width setting that specifies a width of the simulated listening environment corresponding to a selected venue type. As the user increases the width setting, audio effects application 24 increases the amount of surround effects that are applied to the audio output signal being played back by the one or more speakers 16. Additionally, audio effects application 24 increases the amount of reverb effects applied to the audio output signal being played back by the one or more speakers 16. The user can also select a parameter specifying a venue size parameter of the selected venue type. As the user increases the venue size setting, audio effects application 24 increases the amount of reverb that is applied to the audio output signal being played back by the one or more speakers 16.

The user can also select a parameter specifying a listening position. With respect to the listening position, the user can select whether the listening position is near the front, center, rear, or any other position within the simulated listening environment. Based on the selected listening position, audio effects application 24 generates surround, distance, and reverb effects parameters that impact the audio effects applied to an output signal sent to the one or more speakers 16 for playback within the listening environment. Based on the user’s selected listening position within the simulated listening environment, audio effects application 24 selects a surround effects setting from a look-up table associated with the selected listening position. The selected listening position specifies a particular configuration of surround effects that are applied to the output signal. The selected listening position also specifies an amount of distance processing applied to the output signal. Audio effects application 24 also consults a look-up table associated with the selected listening position that specifies a configuration of distance processing effects based on the selection. Similarly, the selected listening position specifies a particular configuration of reverb effects that are applied to the output signal. Audio effects application 24 also consults a look-up table associated with the selected listening position that specifies a configuration of distance processing effects based on the selection.

In one embodiment, audio effects application 24 applies reverb independent of a microphone input signal from the microphone system 18. In another embodiment, to apply reverb audio effects to an audio source 12, audio effects application 24 utilizes a microphone input signal from the microphone system 18. The microphone input signal includes audio captured from within the listening environment. The audio comprises the playback of the audio source 12 within the listening environment with which audio effects application 24 can apply a reverb effect to an output signal sent to the one or more speakers 16.

The one or more user settings also include a volume setting that impacts how loudly audio is played back within the listening environment. The volume setting also impacts one or more properties of the microphone system 18, such as the level of the microphone input signal provided to audio effects application 24. For example, the level of the microphone input signal adjusts based on the volume setting. The microphone system 18 provides a microphone input signal at a relatively low level when the volume setting is either relatively very low or relatively very high. When the volume setting is at an arbitrary middle point, the level of the microphone input signal is also set at a middle point. Controlling the level of the microphone input signal as set forth reduces the possibility of feedback between the audio captured by the microphone system 18 and the audio output by the microphone system 18.

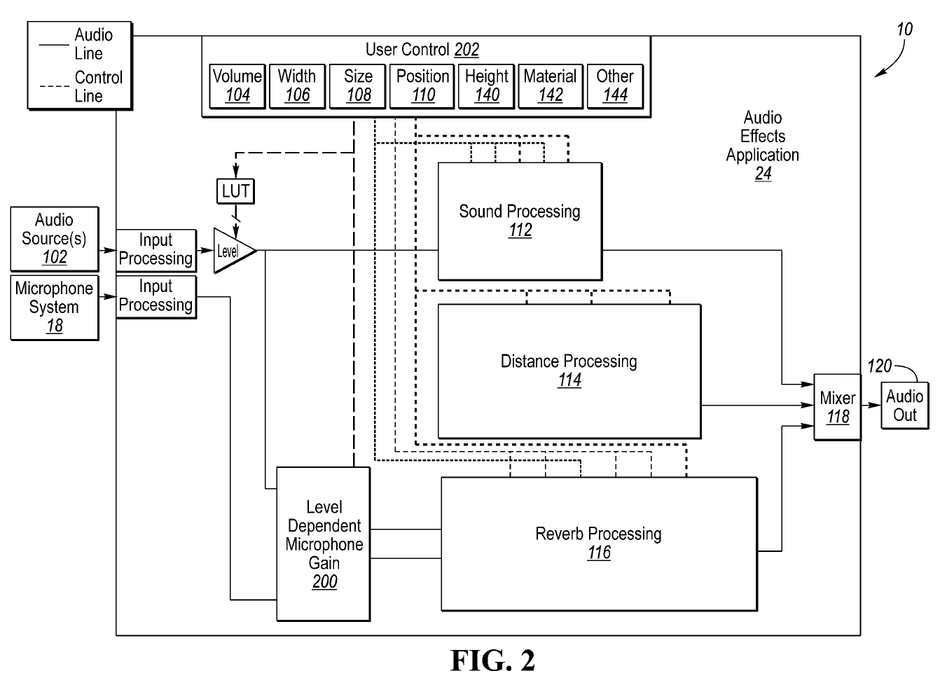

FIG. 2 illustrates an example of the audio effects application 24 applying audio effects to an audio input signal associated with an audio source 12 according to various embodiments. Audio effects application 24 includes, without limitation, user controls 202, surround processing block 112, distance processing block 114, reverb processing block 116, and mixer 118. Audio effects application 24 also generates output signal 120. User controls 202 include, without limitation, a volume input 104, a width input 106, a venue size or length input 108, a venue position input 110. The users controls 202 may also include, without limitation, a venue height 140, venue material 142, or other venue inputs or characteristics.

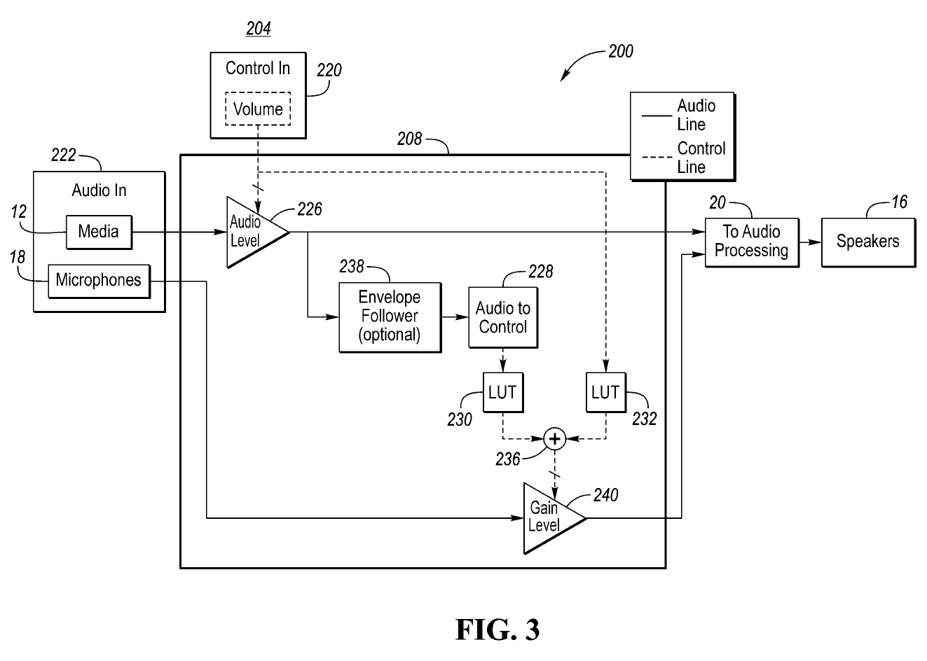

As shown and as described above, audio effects application 24 receives an audio input signal corresponding to an audio source 12 being played back by audio system 10. Audio effects application 24 also receives a microphone input signal from microphone system 18 that corresponds to the sounds being played back within a listening environment by one or more speakers 16 of the audio system 10. Audio effects application 24 further receives one or more user settings that are translated into user controls 202. User settings are selected and configured by a user using a user interface. For example, audio effects application 24 generates a user interface that is rendered by one or more touch screens within the listening environment. Examples of a user interface in which a user selects a user setting are shown in FIGS. 3-8. Based on the user settings selected in a user interface, audio effects application 24 translates the user settings into the user controls 202. In general, the surround sound effect, the distance effect, or the reverb effect are proportional to a user setting corresponding to a distance from a stage within the simulated listening environment or a size of the simulated listening environment. Additionally, the surround sound effect, the distance effect, or the reverb effect are also proportional to a user setting corresponding to a width of the simulated listening environment.

Based upon the user controls 202 translated from the user settings selected by the user, audio effects application 24 configures processing blocks to apply audio effects to the audio input signal corresponding to one or more audio sources 12. Surround processing block 112 applies surround processing effects based upon the width input 106 and venue size or length input 108 and venue position input 110. Surround processing block 112 also applies surround processing effects based on the venue type selected by the user. In one implementation, surround processing block 112 adjusts equalization settings, signal gain, and surround effects settings based on width input 106 for a particular venue type. Based on the value of width input 206, surround processing block 112 consults one or more lookup tables that specify particular equalization settings, signal gain parameters or surround effects settings for a particular value of the width input 206. Additionally, surround processing block 112 applies surround processing effects based upon venue position input 110 and a selected venue type. In one implementation, venue position input 110 and width input 206 are combined to select surround effects settings. Venue position input 110 can be used as an input to a gain setting within surround processing block 112 to specify how much signal gain is applied to the surround effect applied to the audio input signal. Surround processing block 112 outputs a surround processed signal to mixer 118, which mixes together the signals from surround processing block 112, distance processing block 114, and reverb processing block 116 to generate the output signal 120. Output signal 120 is transmitted to the one or more speakers 16 to cause playback of the output of the mixer 118.

Distance processing block 114 applies distance effects based upon the venue position input 110. Distance processing block 114 also applies distance effects based on the venue type selected by the user. In general, the farther away from the stage in a simulated listening environment, the more distance processing effects are applied to the audio input signal. In one implementation, distance processing block 114 performs mid-side processing to the audio input signal to separate the audio input signal into a left and right component from a center component. Distance processing block 114 adds a delay to the component signals based on the amount of distance from the stage in the simulated listening environment that is selected by the user. In one example, the venue position input 110 is provided to a lookup table accessible to 114, which translates the venue position input 110 into a delay amount. Additionally, distance processing block 114 adds a signal gain to the delayed audio input signal based on the venue position input 110. Distance processing block 114 then remixes the component signal into a combined audio input signal. In some examples, an additional signal gain is applied to the combined audio input signal based on the venue position input 110. Distance processing block 114 then outputs a signal to mixer 118.

Reverb processing block 116 adds a reverb effect to the audio input signal based on a microphone input signal from volume input 104, width input 106, venue size or length 108, and venue position input 110. Reverb processing block 116 also adds the reverb effect based on the selected venue type. To apply reverb audio effects to an audio input signal, reverb processing block 116 utilizes the microphone input signal from the microphone system 18. The microphone input signal includes audio captured from within the listening environment. The audio comprises the playback of the audio source 12 within the listening environment with which reverb processing block 116 applies a reverb effect to an output signal sent to the mixer 118. The parameters defining the reverb effect are based on the venue type, volume input 104, width input 106, venue size or length 108, and venue position input 110.

In some embodiments, reverb processing block 116 performs level balancing of the microphone input signal to equalize the level of the microphone input signal with the audio input signal. Then, the level balanced microphone input signal and audio input signal are provided to a mixer. A reverb effect is then added to the mixed signal based on one or more reverb parameters. The reverb parameters include a decay time, an amplitude envelope, a spread, an echo time or level, a high frequency roll-off, a graininess parameter, or other reverb parameters that can characterize how the reverb effect is applied. In one embodiment, the venue size or length 108 is provided to a lookup table within reverb processing block 116 that specifies the reverb parameters based on the value of venue size or length 108. A signal can be applied based upon the venue size or length 108. In general, the larger the venue size or length, the more reverb effect that is applied to the audio input signal. The width input 106 can also affect how much reverb effect is applied to the audio input signal. In general, the wider the venue as specified by a user setting, the more reverb effect is applied to the audio input signal. The venue position input 110 specifies a level of an output of the reverb processing block 116 that is provided to mixer 118. The farther from the stage in the simulated listening environment, the higher the level of the output of the reverb processing block 116 that is provided to the mixer 118. Mixer 118 mixes together the signals from surround processing block 112, distance processing block 114, and reverb processing block 116 to generate the output signal that is provided for playback within the listening environment.

With continuing reference to FIG. 2, in some embodiments, the simulated environmental parameters may include a venue material parameter 142 that represents the acoustic properties of surfaces and furnishings within a venue. The venue material parameter 142 may be used to control how sound is reflected, absorbed, and diffused in the simulated listening environment. For example, venues incorporating plush materials such as carpeting, fabric seating, or draperies generally reduce high-frequency reflections and shorten reverberation time. The audio system 10 may replicate such environments by attenuating high-frequency reflections and applying shorter reverb decay times to create a warmer and more intimate acoustic profile.

In other embodiments, the venue material parameter 142 may specify harder or more reflective surfaces such as wood paneling, polished floors, or lightly furnished walls. These materials may increase the strength of early reflections and extend reverberation times, particularly at mid and high frequencies. To simulate such conditions, the audio system 10 may increase the relative gain of early reflections and extend reverb decay times. In larger environments such as arenas or stadiums constructed with concrete or metal, the audio system 10 may further extend reverb tails, introduce multiple delayed reflections, and emphasize midrange and high-frequency response to reflect the spaciousness and echo characteristics of such venues.

In some embodiments, the simulated environmental parameters may further include other venue input parameters 144 (FIG. 2). For example, the venue input parameters 144 may include a venue enclosure parameter that indicates whether the venue is open-air or enclosed. Open-air venues typically allow sound energy to dissipate freely, resulting in reduced reverberation and fewer late reflections. The audio system 10 may simulate this by reducing reverb decay times, and attenuating late reflections to create a direct and less enveloped sound. By contrast, enclosed venues such as domed stadiums introduce multiple reflective surfaces, producing longer reverberation times and pronounced echoes. To emulate such conditions, the audio system 10 may extend decay times, enhance mid- and low-frequency response, and apply complex reflection patterns to replicate the acoustic behavior of an enclosed space.

In further embodiments, the audio system 10 may be configured to allow a user to select a specific real-world venue through the user interface 30. The user interface 30 may provide various inputs, including a volume input 104, a width input 106, a venue size or length input 108, a venue position input 110, a venue height input 140, and a venue material input 142 or other venue input 144. Upon receiving a user selection of a known venue, the audio system 10 may retrieve or characterize the acoustic properties of the venue using available data sources. Artificial intelligence or machine learning techniques may be employed to analyze audio recordings, architectural data, material specifications, or imagery to estimate venue parameters such as dimensions, enclosure type, materials, and reflection patterns.

Based on the characterized data, the processing unit 20 may generate input settings that replicate the acoustic environment of the selected venue. These input settings may include parameters such as venue size or length 108, width 106, height 140, enclosure type, and material profiles 142. The audio system 10 may then apply the input settings to the immersive audio processing architecture so that playback mimics the acoustic qualities of the real-world venue. As a result, a user selecting a specific venue such as Red Rocks Amphitheatre or the Staples Center may experience audio processing that reproduces the unique acoustic character of those venues.

In some embodiments, the controller 26 may be configured to store a plurality of preset venues. Each preset venue may be defined by at least two venue input settings selected from the group consisting of a venue width input 106, a venue size or length input 108, a listener position input 110, a venue height input 140, a venue material input 142, and a venue enclosure input. The preset venues may serve as default configurations that simplify the user’s selection process by automatically applying a set of venue input values that correspond to a particular listening environment.

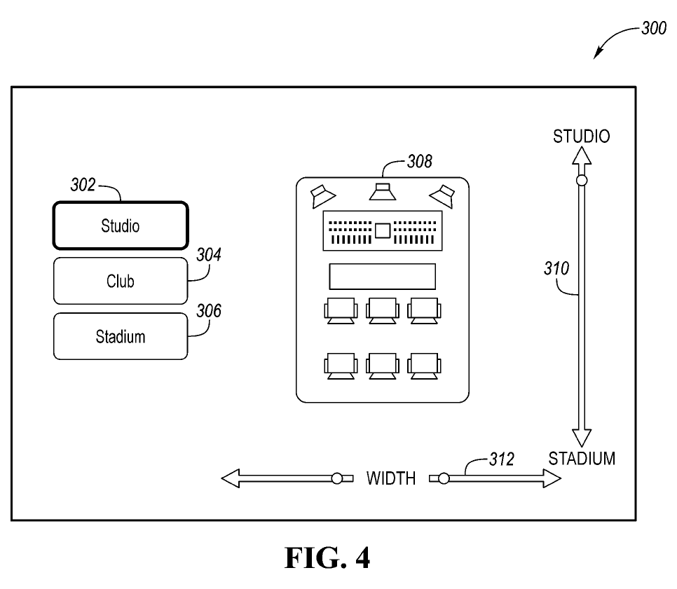

In further embodiments, and with reference to FIGS. 4-8, the preset venues may include at least a studio preset 302, a club preset 304, and a stadium preset 306. The studio preset 302 may correspond to the venue width input 106 and the venue size or length input 108 being small, providing an intimate acoustic environment with reduced immersion. The club preset 304 may correspond to the venue width input 106 and the venue size or length input 108 being midsized, producing moderate reflections and reverberation. The stadium preset 306 may correspond to the venue width input 106 and the venue size or length input 108 being large, generating extended reverberation and strong reflections. In this manner, the controller 26 may apply different parameter sets to reproduce distinct venue types that represent common real-world listening spaces.

In some embodiments, the user interface 30 may include venue width and venue size or length inputs 106, 108 that allow the user to modify one or more of the predefined values of a selected preset venue. For example, a user may begin with a stadium preset 306 but adjust the venue width input 106 to create a narrower acoustic field, or reduce the venue size or length input 108 to simulate sitting closer to the stage. By enabling such modifications, the audio system 10 allows a balance between convenient preset selections and personalized adjustment, ensuring that users can tailor their immersive experience according to individual preferences.

In some embodiments, the user interface 30 may be configured to allow the user to select a specific, known venue. The controller 26 may include a lookup table (LUT) configured to store venue information. The LUT may include a plurality of known venues, each associated with a corresponding set of simulated environmental parameters. For example, the LUT may store entries for venues such as Red Rocks Amphitheatre, the Hollywood Bowl, the Staples Center or other popular listening venues. Each known venue is linked to specific acoustic characteristics including reverberation time, reflection strength, and material properties. When a user selects one of the known venues, the controller 26 may retrieve the corresponding parameter set from the LUT and apply it to the audio source signal, allowing the playback to emulate the acoustic qualities of that venue.

In further embodiments, the controller 26 may access remote venue information for the selected known venue. The controller 26 may connect to a local database or a network or cloud-based resource to access venue information associated with the selected venue. The controller 26 may then characterize one or more simulated environmental parameters, including venue size or length 108, venue width 106, venue height 140, material 142, and enclosure type, based on the accessed venue information. The controller 26 may apply the characterized parameters to modify the audio source signal so that playback reproduces the acoustic properties of the selected venue.

The audio system 10 may further enable the user to specify a listening position within the selected venue. The user interface may include a position input 110 (FIG. 2) allowing the user to choose a location relative to the stage or sound source, such as a front-row, upper balcony position, for example. The controller 26 may use this position input 110 in combination with the venue information to refine the simulated environmental parameters. For example, a front-row position may emphasize direct sound with reduced reverberation, while a rear or balcony position may increase the contribution of reflected sound to create a more diffuse and spacious effect. By combining venue-specific acoustic data with the user’s positional input, the audio system 10 can accurately simulate how the same performance would sound from different listening locations within the selected venue.

FIG. 3 illustrates a system 200 for adjusting gain in a captured audio input signal. The system 200 enables dynamic control of audio processing through real-time analysis and adjustment of microphone gain. U.S. Patent Application Serial 19/009,665 by Skyler Schmidt et al. and assigned to Harman Becker Automotive Systems, Inc, describes a system and method for providing level-dependent microphone gain, and is hereby incorporated by reference in its entirety. In particular, a system and method for providing level-dependent microphone gain may be applied to the audio system 10 described herein, such as in FIGS. 1A-1B. The audio system may be used in in-vehicle audio systems, designed to dynamically adjust microphone input levels to enhance the overall audio experience. The audio system manages microphone gain by incorporating post-volume media input into the signal processing path. This ensures consistent and optimized performance during various audio use cases, such as hands-free communication and immersive sound experiences, as disclosed in U.S. Patent 10,728,691 by Trestain et al.

Unlike traditional methods that rely solely on volume-dependent scaling, the system 200 incorporates media level analysis to provide a more adaptive response. For example, when the volume is high, but media playback is paused or low, the system dynamically adjusts the microphone gain to maintain optimal signal clarity without unnecessary attenuation. Conversely, during high-volume playback, the system balances microphone levels to minimize feedback. This dynamic control provides real-time signal analysis, allowing the system to adapt to changing and immersive audio conditions and still deliver a consistent microphone control in the vehicle cabin.

The system 200 may control the microphone input level within the audio processing path by dynamically calibrating parameters such as reverb based on media playback levels and user interactions. By continuously analyzing and adjusting the microphone input in real-time, the system maintains an immersive audio environment while ensuring the clarity of voice and other signals captured by in-cabin microphones.

This solution in system 200 is adaptable across a range of applications both in-vehicle or outside vehicles in other listening spaces including immersive audio demonstrations, standard voice operations, and hands-free operation or in any situation where precise microphone gain control is advantageous. These aspects and others will be discussed in more detail below.

FIG. 3 generally depicts a system or audio system 200 for adjusting a captured audio input signal. The captured audio input signal is provided by at least one microphone 18 positioned in a listening space 204. In at least one embodiment, the listening space 204 includes a vehicle passenger cabin. Microphones 18 in a vehicle passenger cabin may be positioned to capture audio for various in-cabin applications. For example, the microphones 18 may be positioned in the headliner near the driver and front passenger to capture clear voice inputs for hands-free communication and voice recognition systems. Additional microphones 18 may be embedded in the rearview mirror, sun visors, A-pillars, or other positions within the cabin to provide balanced audio coverage across the cabin. For immersive audio or concert-like experiences, microphones 18 may also be positioned in locations that enhance spatial sound processing, such as near the rear seats or at key reflective points within the cabin.

The system 200 also has an audio line from a media and audio source 12. The media and audio source 12 may accept media audio signals, which may originate from a variety of sources, such as streaming services, radio, or onboard media players such as an FM station, an AM station, a High Definition (HD) audio station, a satellite radio provider, an input from cell phone, an input from a tablet, or others. A media control block 222 provides an input media signal to a system controller 208 from the media and audio source 12.

The system 200 includes at least one controller 208 for receiving the audio input signal from each of the microphones 18 and the input media signal from the media and audio source 12. The controller 208 may be operably coupled to one or more loudspeakers 16 positioned in the listening space 204, such as in a vehicle. The controller 208 may transmit an audio output signal to the loudspeakers 16 to playback the captured audio. An audio processing unit 20 is provided to process the audio output signal provided by the controller 208 prior to the audio output signal being provided to the loudspeakers 16.

A volume control block 220 is operably coupled to the controller 208 to provide input of the volume setting. The volume control block 220 provides the volume setting based on various control signals received from user inputs, system setting or custom profiles, for example. The system typically allows manual adjustment of volume through physical controls, such as knobs, buttons, or touchscreens, or via voice commands. The system may also adjust the volume based on feedback from conditions, such as ambient noise levels or media playback characteristics, wherein the system can automatically adjust volume levels to maintain optimal listening conditions. The volume control block 220 provides these volume settings as a volume input signal to the controller 208.

The system 200 provides a first audio level block 226 that processes the media input from the media and audio source 12 and the volume input signal from the volume control block 220. The initial audio level signal is a function of the media source input and the volume setting input.

The controller 208 includes audio to control block 228, a first lookup table (LUT) 230, a second LUT 232, and a gain level block 240. In general, the controller 208 receives the media inputs and volume inputs to determine the media or microphone level. In prior systems, at normal volume levels, there would be no or only nominal microphone gain, while at higher volumes, where microphones may pick up speaker output, the microphone gain is reduced to avoid feedback. However, this past approach lacks dynamic adjustment based on contextual factors like media playback levels. The present disclosure provides adaptive control that dynamically optimizes microphone gain in real time, ensuring superior performance and user experience.

For example, the controller 208 can adapt to dynamic changes in the level of the audio, such as where the volume setting is high, but the audio is paused, or the media is low and does not need to turn down the microphone gain or mute the microphone. The present disclosure is dependent on volume, but also is dependent on the audio level 226.

In this regard, the audio to control block 228 may correlate the received audio level input signal to generate a corresponding control signal. The audio levels may be measured in decibels (dB) representing the relative intensity or power of sound or relative values such as dBV (relative to 1 volt) or dBFS (decibels relative to full scale, where 0 dBFS represents the maximum level, and other values are negative), or other level value that may quantifying acoustic sound in a space, signal amplitudes in devices, power levels or other characteristics in the system.

In one example, assuming that audio level is equal to an average or high level of 60dB or more, then the first LUT 230 may provide a first gain level to attenuate or reduce the gain of captured audio input signal of the microphone when audio level is low. Further, for example, assuming that audio level is equal to a low level, such as 20dB to 50db, then the first LUT 230 may provide a first gain level of to amplify the microphone when audio level is low. The first LUT 230 may include a plurality of audio values that are associated with various microphone gains. The first LUT 230 may be independent of volume.

The volume setting may be analyzed separately to adjust the captured audio input signal at a corresponding gain value set forth in the second LUT 232. For example, the second LUT 232 may include a plurality of volume setting values that are associated with various gain levels. In this regard, the second LUT 232 may provide a corresponding gain level.

The controller 208 combines the outputs of the two LUTs 230, 232 at the summation node 236. The data processed by each LUT 230, 232 contributes to the total gain value. The first gain level from the first LUT 230 and the second gain level from the second LUT 232 may be combined additively. Inputs to the LUTs 230, 232 are processed individually and then combined into a single output at the summation node 236. The controller 208 combines two distinct control parameters, such as media level and volume setting. This configuration using modular processing enables dynamic and flexible signal processing.

The summation node 236 may provide a corresponding total gain level (or total volume/gain level) to the gain level block 240 based on the volume and media level. In contrast, in conventional audio systems, microphone gain is typically scaled with only volume settings to manage levels and prevent feedback.

It is recognized that the controller 208 may utilize one or more of the first LUT 230 and/or the second LUT 232 to increase, or amplify, the gain on the captured audio input signal provided by the microphone 18. For example, the controller 208 may adjust and increase the gain at the gain level block 240 when the volume setting is high, and the media level is low. In another example, the controller 208 may adjust and increase the gain at the gain level block 240 when the volume setting is low, and the media level is high. In yet another example, the controller 208 may adjust and increase the gain at the gain level block 240 when the volume setting is low, and the media level is low. The system 200 may utilize the first LUT 230 and/or the second LUT 232 and the implementation of utilizing the total gain level (e.g., volume/gain level) to amplify the captured audio input signal.

It is also recognized that the controller 208 may utilize one or more of the first LUT 230 and/or the second LUT 232 to reduce, or attenuate, the gain on the captured audio input signal provided by the microphone 18. For example, the controller 208 may adjust and decrease the gain of the gain level block 240 when the volume setting is high, and the media level is high. The system 200 may utilize the first LUT 230 and/or the second LUT 232 and the implementation of utilizing the total gain level (e.g., volume/gain level) to attenuate the captured audio input signal.

The controller 208 may optionally include an envelope follower 238. The envelope follower 238 may provide additional control of the media input signal. For example, the envelope follower 238 may track amplitude variations of the incoming audio signal over time, producing a control signal that represents the signal's envelope or dynamic level. The envelope follower 238 may provide more granular or specific control when needed.

An audio processing unit 20 is provided to process the audio output signal provided by the controller 208 prior to the audio output signal being provided to the loudspeakers 16.

The system 200 may be specifically configured for in-vehicle use, where dynamically adjusting microphone gain and media playback levels in real time may enhance the audio experience. By analyzing both volume settings and media playback levels, the system 200 ensures that microphone inputs are appropriately balanced, even in scenarios where media playback is paused or at a low volume. This approach minimizes feedback and maintains voice clarity to integrate media and voice interactions. The system 200 adjusts the captured audio to enhance applications such as hands-free communication, immersive audio environments, and adaptive soundscapes tailored to the in-vehicle experience.

In another example, the system 200 may also support karaoke applications, both in-vehicle and in other environments. During karaoke sessions, the system 200 may adjust the microphone gain in real-time based on the music or media playback, ensuring that the singer’s voice blends seamlessly with the background music, even during variations of the media level. This real-time adjustment may prevent overpowering or muffling of the vocal signal, for example, as the level of the song varies. The system 200 may function effectively in both automotive settings and external applications such as home karaoke systems or public entertainment venues where the listening space 204 may be a room in a home or a room in the entertainment venue or any suitable space.

The system 200 may have other consumer uses, such as in smart speakers, home entertainment systems, and personal audio devices that use one or more microphones 18 in a listening space 204. For instance, in smart speaker applications, the system can dynamically adjust microphone gain to ensure clear voice recognition while maintaining media playback volume. In typical smart speaker systems, when the user speaks in it, it turns the music or media down. But, in the system 200, the microphone gain could actually be increased when the volume of the media level is maintained.

Similarly, in home audio systems, the system 200 can enhance immersive listening experiences by adapting to user interactions without pausing or lowering media volume during voice input with one or more microphones 18. Additionally, the system 200 could be applied to portable devices or gaming setups, where dynamic microphone and audio control enhance communication clarity and immersive soundscapes. The system 200 may be suitable for a wide range of consumer audio applications.

It is recognized that the controllers may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, the controllers utilize one or more microprocessors to execute a computer-program that is embodied in a non-transitory computer readable medium that is programmed to perform any number of the functions as disclosed. Further, the controllers include a housing and the various number of microprocessors, integrated circuits, and memory devices (e.g., FLASH, random access memory (RAM), read only memory (ROM), electrically programmable read only memory (EPROM), electrically erasable programmable read only memory (EEPROM) are positioned within the housing. The controllers also include hardware-based inputs and outputs for receiving and transmitting data, respectively from and to other hardware-based devices.

For example, the controller 208 may be a suitable digital signal processor (DSP) for conducting the audio signal processing. The controller 208 may include multiple or separate microprocessors, integrated circuits, memory devices, RAM, ROM, EPROM, EEPROM, software or other suitable controllers to process the media/music and also process the microphone read only memory (ROM), electrically programmable read only memory (EPROM), electrically erasable programmable read only memory (EEPROM), or other suitable variants thereof, and software. The DSP for processing the microphone and media/music signals could be located within a vehicle amplifier, computer, a vehicle head unit, central computer, domain controller, digital audio interface/mixer or other suitable digital signal processor.

In another embodiment, the volume input block 220 and/or the media input block 222 may be provided within a head unit or audio playback device. The head unit may be used in automotive infotainment systems and is capable to interface with vehicle systems, multimedia content, and communication devices. The head unit may include a central processing module configured to manage audio, video, and connectivity operations, paired with a high-resolution touchscreen display for user interaction. The head unit may be configured with wireless communication interfaces, including Bluetooth® and Wi-Fi®, to support hands-free calling, media streaming, and connectivity with mobile devices. The head unit may also be integrated with various external components, such as amplifiers, cameras, and navigation systems.

Referring now to FIG. 4, a user interface 300 is shown according to various embodiments. The user interface 300 is generated by audio effects application 24 and presented on one or more input and output devices 14 in the listening environment. The user interface 300 allows the user to select one or more user settings that determine the audio effects that are applied to an audio input signal and provided as an output signal to the one or more speakers 16. As shown in FIG. 4, the user interface 300 includes a studio venue type selection element 302, club venue type selection element 304, and stadium venue type selection element 306. By selecting one of the venue type selection elements, audio effects application 24 determines one or more preset settings for venue size or length input 108, volume input 104, width input 106, venue size or length input 108, and venue position input 110. In the example shown, the user has selected studio preset selection element 302, which corresponds to a studio venue type for the simulated listening environment. In response to selecting the studio preset selection element 302, audio effects application 24 displays an image 308 corresponding to the selected venue type.

The user interface 300 further includes a venue size slider 310 with which the user can modify the size of the simulated listening environment from relatively small to relatively large. In some implementations, audio effects application 24 allows the user to select different sized venues within a selected venue type. For example, the audio effects application 24 can provide multiple studio sizes, multiple club sizes, and multiple stadium sizes. User interface 300 also includes a width slider 312 with which a user can specify a width setting corresponding to the simulated listening environment. Based upon the selected studio preset selection element 302, the venue size slider 310, and width slider 312, audio effects application 24 determines the user controls 202 that are used to configure the audio effects applied to an audio input signal to generate an output signal played back by one or more speakers 16 of the audio system 10.

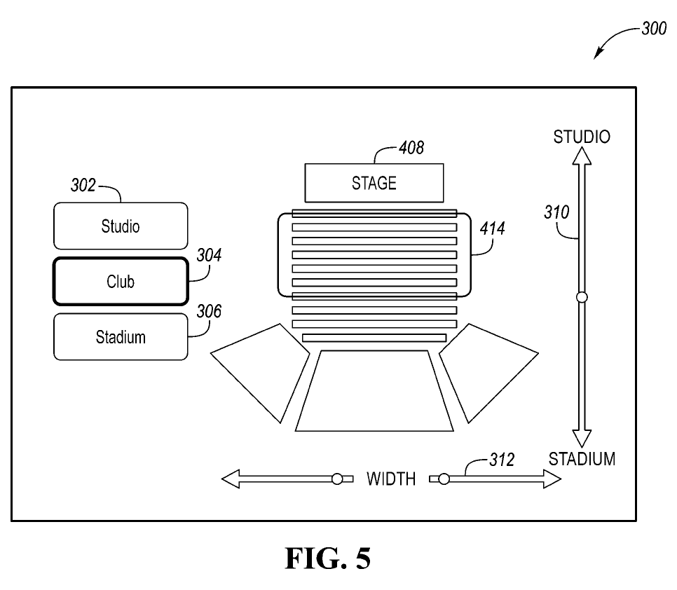

Continuing the example of FIG. 4, reference is made to FIG. 5. FIG. 5 depicts a user interface 300 according to various embodiments. In the example of FIG. 5, a user has selected club preset selection element 304, which causes audio effects application 24 to associate the simulated listening environment with a venue type of a club listening environment. In general, a club listening environment is larger than a studio venue type. Accordingly, audio effects application 24 selects a larger venue size or length input 108 in response to selection of the club preset selection element 304 from studio preset selection element 302. Additionally, audio effects application 24 updates the image 308 of the studio venue type to an image 408 of a club venue type.

In the example of FIG. 5, the user selects a seating location within the simulated listening environment, which is indicated by selector component 414. In response to selecting the seating location, audio effects application 24 updates the venue position input 110. Based upon the selected club preset selection element 304, the venue size slider 310, width slider 312, and seating location indicated by selector component 414, audio effects application 24 determines the user controls 202 that are used to configure the audio effects applied to an audio input signal to generate an output signal played back by one or more speakers 16 of the audio system 10.

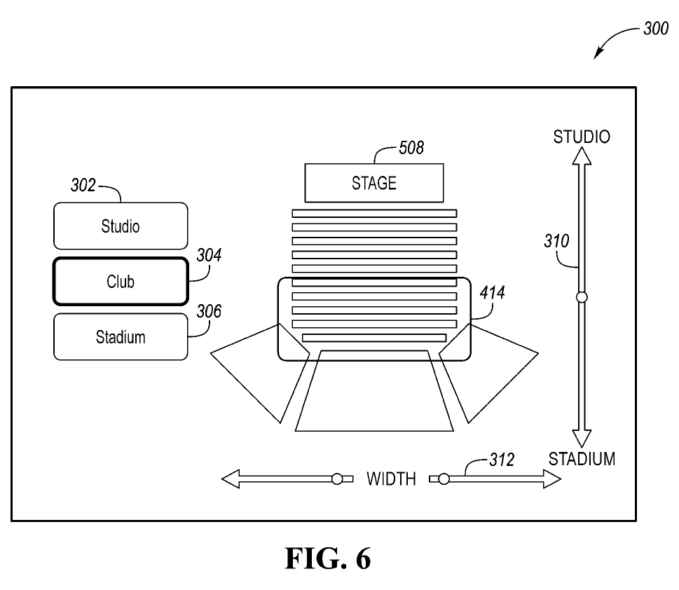

Continuing the example of FIG. 5, reference is now made to FIG. 6. FIG. 6 depicts a user interface 300 according to various embodiments. In the example of FIG. 6, a user has again selected club preset selection element 304, which causes audio effects application 24 to associate the simulated listening environment with a venue type of a club listening environment. As noted above, a club listening environment is larger than a studio venue type. Accordingly, audio effects application 24 selects a larger venue size or length input 108 in response to selection of the club preset selection element 304 relative to when studio preset selection element 302 is selected.

In the example of FIG. 6, the user selects a different seating location within the simulated listening environment relative to the example shown in FIG. 5, which is indicated by selector component 414. The seating location is farther from stage 508 in the simulated listening environment compared to the example of FIG. 6. In response to selecting the seating location, audio effects application 24 updates the venue position input 110 to reflect a greater distance than in the example of FIG. 5. Based upon the selected club preset selection element 304, the venue size slider 310, width slider 312, and seating location indicated by selector component 414, audio effects application 24 determines the user controls 202 that are used to configure the audio effects applied to an audio input signal to generate an output signal played back by one or more speakers 16 of the audio system 10.

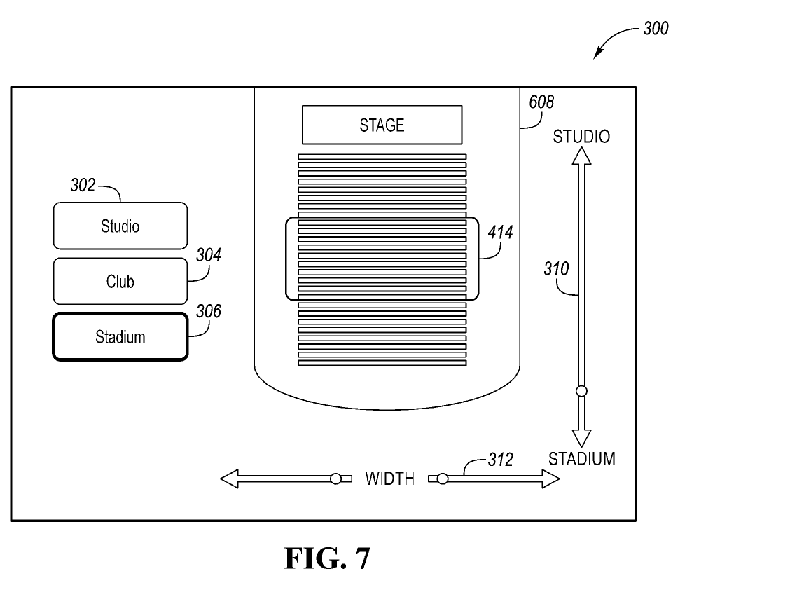

Continuing the example of FIG. 6, reference is now made to FIG. 7. FIG. 7 depicts a user interface 300 according to various embodiments. In the example of FIG. 7, a user has selected stadium preset selection element 306, which causes audio effects application 24 to associate the simulated listening environment with a venue type of a stadium listening environment. A stadium listening environment is larger than a studio or a club listening environment. Accordingly, audio effects application 24 selects a larger venue size or length input 108 in response to selection of the stadium preset selection element 306 relative to when studio preset selection element 302 or club preset selection element 304 are selected. Audio effects application 24 also updates the user interface 300 with image 608, providing a graphical representation of the simulated listening environment.

In the example of FIG. 7, the user can also select a seating location within the simulated listening environment, which is again indicated by selector component 414. In response to selecting the seating location, audio effects application 24 updates the venue position input 110. Based upon the selected stadium preset selection element 306, the venue size slider 310, width slider 312, and seating location indicated by selector component 414, audio effects application 24 determines the user controls 202 that are used to configure the audio effects applied to an audio input signal to generate an output signal played back by one or more speakers 16 of the audio system 10.

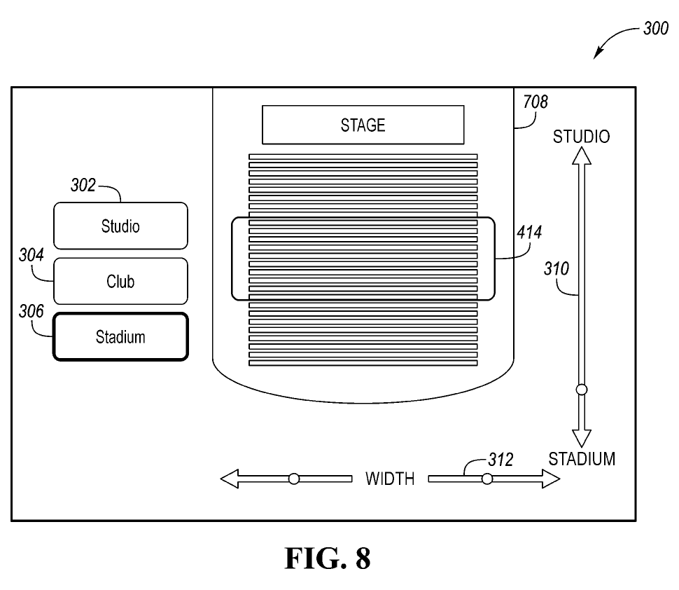

Continuing the example of FIG. 7, reference is now made to FIG. 8. FIG. 8 depicts a user interface 300 according to various embodiments. In the example of FIG. 8, a user has again selected stadium preset selection element 306, which causes audio effects application 24 to associate the simulated listening environment with a venue type of a stadium listening environment. Accordingly, audio effects application 24 selects a larger venue width input 106 and/or venue size or length input 108 in response to selection of the stadium preset selection element 306 relative to when studio preset selection element 302 or club preset selection element 304 are selected.

In the example of FIG. 8, the user has also adjusted width slider 312 to select a wider simulated listening environment relative to the example of FIG. 7. In response to adjusting the width of the simulated listening environment, audio effects application 24 updates the image of the simulated listening environment with image 708, depicting a wider simulated listening environment than in the example of FIG. 7. Audio effects application 24 also updates the width input 106 corresponding to the wider simulated listening environment. Based upon the selected stadium preset selection element 306, the venue size slider 310, width slider 312, and seating location indicated by selector component 414, audio effects application 24 determines the user controls 202 that are used to configure the audio effects applied to an audio input signal to generate an output signal played back by one or more speakers 16 of the audio system 10.

In sum, an audio effects application receives an audio input signal corresponding to an audio source and a microphone input signal. The audio effects application also receives at least one user setting corresponding to a simulated listening environment and determines a plurality of effects processing parameters based on the at least one user setting and the microphone input signal. The audio effects application also generates an output signal based on the audio input signal, the microphone input signal, and the plurality of effects processing parameters and outputs the output signal to one or more speakers.

At least one technical advantage of the disclosed approach relative to the prior art is that, with the disclosed techniques, users of an audio system 10 can select a simulated listening environment to enjoy audio output by the audio system 10. The simulated listening environment causes audio effects to be applied to sound that is output by an audio system 10 that approximates different types of live event venues according to a user preference. Additionally, by allowing the user to select from different simulated listening environments that are equated to different types of live event venues, the disclosed techniques provide guardrails with respect to the equalization and audio effects settings of the audio system 10 that prevent the user from selecting audio effects or equalization settings that result in a poor listening experience. As a result, users enjoy enhanced personalization of their auditory experience in the listening environment. These technical advantages provide one or more technological improvements over prior art approaches.

In addition to providing user-selectable simulated venues, audio system 10 according to the present disclosure provides additional technical advantages with the signal processing architecture having three parallel processing paths respectively dedicated to surround or immersion processing 112, distance processing 114 and reverb processing 116. The parallel processing paths allow the audio system 10 to independently manipulate spatial cues, source distance perception, and reverberation characteristics while maintaining real-time synchronization of the processed audio output. In contrast to prior art systems that rely on serial or single-path processing, the audio system 10 of the present disclosure links user inputs 106-144 to multiple processing paths simultaneously. A user adjustment to one of these inputs 106-144 allows coordinated modification to the surround, distance, and reverb processors, ensuring a coherent and perceptually accurate change in the simulated acoustic space in real-time achieving a level of spatial realism and responsiveness not attainable by conventional single-path or isolated processing systems.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An audio system comprising:
at least one speaker configured to reproduce an audio output within a listening environment;
a user interface configured to receive user input for adjusting a venue input setting for a desired simulated venue within the listening environment;
a microphone configured to capture ambient sound within the listening environment and generate a microphone signal; and
a controller in communication with the user interface and programmed to:
receive an audio source input signal;
determine at least one simulated environmental parameter based on the venue input setting;
generate an audio signal for the at least one speaker to adjust the audio output the based on the simulated environmental parameter; and
transmit the audio signal to the at least one speaker.

2. The audio system of claim 1, wherein the controller is further configured to store a plurality of preset venues, each preset venue being defined by at least two venue input settings selected from the group consisting of: a venue width, a venue size, and a listener position, a venue height input, a venue material input, and a venue enclosure input.

3. The audio system of claim 2, wherein the plurality of preset venues includes a plurality of venue presets including at least a first venue preset, a second venue preset, and a third venue preset, each of the plurality of venue presets being configured with predefined values for the at least two venue input settings,
wherein the first venue preset corresponds to the venue width and the venue size being small and less than the second venue preset and the third venue preset,
wherein the second venue preset corresponds to the venue width and the venue size being midsized and less that the third venue preset, and
wherein the third venue preset corresponds to the venue width and the venue size being large and greater than the first venue preset and the second venue preset.

4. The audio system of claim 3, wherein the user interface comprises a venue width input and a venue size input configured to allow a user to modify one or more of the plurality of venue presets.

5. The audio system of claim 1, wherein the controller is further programmed to process the microphone signal to apply the at least one simulated environmental parameter such that the audio output includes a processed ambient sound from the microphone based on the simulated environmental parameter.

6. The audio system of claim 5, wherein the controller is further programmed to:
receive an audio input signal indicative of an audio playback level and a volume control signal indicative of a playback volume setting; and
adjust a gain applied to the microphone signal based on the playback volume setting.

7. The audio system of claim 6, wherein the controller is further programmed to:
adjust the gain to the microphone signal in real time during playback of the audio source input signal.

8. The audio system of claim 6, wherein the controller is further programmed to:
continuously monitor the audio playback level and the playback volume setting and dynamically update the gain without interrupting or delaying the playback of the audio source input signal.

9. The audio system of claim 1, wherein the at least one simulated environmental parameter comprises a venue material parameter corresponding to one or more acoustic properties of a material associated with the desired simulated venue, and wherein the controller is configured to apply the venue material parameter to modify the audio source input signal.

10. The audio system of claim 1, wherein the at least one simulated environmental parameter comprises a venue enclosure parameter indicating whether the desired simulated venue is open-air or enclosed, and wherein the controller is configured to modify the audio source input signal based on the venue enclosure parameter.

11. The audio system of claim 1, wherein the user interface is configured to receive an input of a selected known venue from a user, and wherein the controller is programmed to apply the at least one simulated environmental parameter associated with the selected known venue.

12. The audio system of claim 11, wherein the controller includes a lookup table (LUT) that includes the selected known venue and the at least one simulated environmental parameter associated with the selected known venue.

13. The audio system of claim 11, wherein the controller is programmed to:
access remote venue information for the selected known venue;
analyze the remote venue information; and
determine the at least one simulated environmental parameter associated with the selected known venue.

14. The audio system of claim 1, wherein the user interface is implemented on a mobile computing device configured to communicate with the controller, and wherein the mobile computing device is configured to transmit the venue input setting associated with the desired simulated venue to the controller via a wired or wireless communication link.

15. The audio system of claim 1, wherein the user interface comprises a graphical user interface integrated into a vehicle.

16. The audio system of claim 1, wherein the user interface further comprises a voice control system configured to receive spoken commands from a user for adjusting the venue input setting.

17. The audio system of claim 1, wherein the controller is further programmed to:
receive a first signal from the user interface with a first venue input setting;
determine a first simulated environmental parameter based on the first venue input setting;
generate a first output signal;
receive a second signal from the user interface with a second venue input setting;
determine a second simulated environmental parameter based on the second venue input setting; and
generate a second output signal in real-time.

18. The audio system of claim 1, wherein the at least one simulated environmental parameter comprises a reverb effect applied to the audio source input signal.

19. The audio system of claim 1, wherein the at least one simulated environmental parameter comprises at least one of a surround sound effect, a distance effect, or a reverb effect.

20. The audio system of claim 1, wherein the user interface further comprises a plurality of user interface elements for adjusting in real time at least one of a width, a size, or a seating position within the desired simulated venue.
